(19) United States
(12) Patent Application Publication
(10) Pub. No.: US 2026/0081232 A1
(43) Pub. Date: Mar. 19, 2026

(54) METHYL ACETATE SOLVENT FOR ENERGY STORAGE DEVICE

(71) Applicant: Tesla, Inc., Austin, TX (US)

(72) Inventors: Remi Petibon, Mont-Royal (CA); Sunny Hy, Mountain View, CA (US)

(21) Appl. No.: 19/330,288

(22) Filed: Sep. 16, 2025

Related U.S. Application Data
(60) Provisional application No. 63/695,040, filed on Sep. 16, 2024.

(51) Int. Cl. H01M 10/0569; H01M 10/0525; H01M 10/0567; H01M 10/0568

(52) U.S. Cl. CPC H01M 10/0569; H01M 10/0525; H01M 10/0567; H01M 10/0568; H01M 2220/20; H01M 2300/0037

(57) ABSTRACT

An electrolyte solution may include a solvent comprising: methyl acetate, ethylene carbonate. A device may include a lithium salt component.

### CROSS-REFERENCE TO RELATED APPLICATION

This application claims the benefit of priority to U.S. Provisional Patent Application Ser. No. 63/695,040 entitled “METHYL ACETATE SOLVENT FOR ENERGY STORAGE DEVICE,” filed Sep. 16, 2024, the disclosure of which is incorporated herein in its entirety by reference.

### BACKGROUND

Energy storage devices, such as lithium-ion batteries, can play a crucial role in various applications including electric vehicles and portable electronics. The performance of these devices is heavily influenced by the composition of their electrolyte solutions. Conventional electrolytes often face challenges in achieving fast charging capabilities while maintaining long-term stability and safety.

### SUMMARY OF THE DISCLOSURE

In some aspects, the techniques described herein relate to an electrolyte solution including: a solvent including: methyl acetate; ethylene carbonate; and a lithium salt component.

In some aspects, the techniques described herein relate to an electrolyte solution including: a solvent including: methyl acetate in a range of from about 5 wt % to about 50 wt % of the solvent; and ethylene carbonate in a range of from about 2 wt % to about 19 wt % of the solvent; and a lithium salt component including lithium hexafluorophosphate (LiPF6), lithium bis(fluorosulfonyl)imide (LiFSi), or a combination thereof, wherein a concentration of the lithium salt is in a range of from about 0.6 to about 1.8 m.

In some aspects, the techniques described herein relate to an electrolyte solution including: a solvent including: methyl acetate in a range of from about 5 wt % to about 50 wt % of the solvent; and ethylene carbonate in a range of from about 2 wt % to about 19 wt % of the solvent; a lithium salt component including lithium hexafluorophosphate (LiPF6), lithium bis(fluorosulfonyl)imide (LiFSi), or a combination thereof, wherein a concentration of the lithium salt is in a range of from about 0.6 m to about 1.8 m; and an additive component including 1,3,2-Dioxathiolane 2,2-dioxidee (DTD), 1-Propene 1,3-Sultone (PRS), bis-1,3,2-Dioxathiolane 2,2-dioxide (bis-DTD), Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide or a mixture of at least two thereof.

In some aspects, the techniques described herein relate to an energy storage device including: a cathode; an anode a separator between the cathode and the anode; and an electrolyte solution including: a solvent including: methyl acetate; ethylene carbonate; and a lithium salt component.

In some aspects, the techniques described herein relate to a method of fabricating an energy storage device, the method including: placing a separator between a cathode and an anode; inserting the cathode, the anode, and the separator into a housing; adding an electrolyte solution to the housing; and contacting the electrolyte solution with the cathode and the anode, wherein the electrolyte solution includes: a solvent including: methyl acetate; ethylene carbonate; and a lithium salt component.

In some aspects, the techniques described herein relate to a vehicle, including: a motor, the motor providing propulsion power to the vehicle; and an energy storage device coupled to the motor and providing energy to the motor, wherein the energy storage device including: a cathode; an anode a separator between the cathode and the anode; and an electrolyte solution including: a solvent including: methyl acetate; ethylene carbonate; and a lithium salt component.

Some present examples seek to provide electrolyte formulations that can enhance charging speeds without compromising other performance parameters such as capacity retention, cycle life, and gas generation. Additionally, a balance of solvents, lithium salts, and additives in the electrolyte solution seeks to optimize overall performance and longevity of energy storage devices.

### BRIEF DESCRIPTION OF THE FIGURES

The drawings illustrate generally, by way of example, but not by way of limitation, various aspects of the present disclosure.

FIG. 1 shows a side cross-sectional schematic view of an example of an energy storage device to which the aforementioned electrolyte solution can be incorporated.

FIG. 2 is a high level diagram of an example vehicle, according to some aspects.

FIG. 3 is a graph showing the Full Charge (FC) time calculated at 40° C. of various lithium-ion batteries differing in their electrolyte solution composition.

FIGS. 4A and 4B are graphs showing energy loss of various lithium-ion batteries measured at 40° C. differing in their electrolyte solution compositions.

FIGS. 5A and 5B are graphs showing the (discharge capacity retention) DCR growths of the lithium-ion batteries of FIGS. 4A and 4B, measured at 40° C.

FIG. 6 is a graph showing the impact of the concentration of LiFSi in the electrolyte solution on a lithium-ion battery's full charge time.

FIG. 7 is a graph showing the impact of the concentration of LiFSi in the electrolyte solution on a lithium-ion battery's capacity loss.

FIG. 8 is a graph showing the impact of the concentration of LiFSi in the electrolyte solution on a lithium-ion battery's DCR growth

FIG. 9 is a graph showing the impact of the concentration of LiFSi in the electrolyte solution on a lithium-ion battery's anode charge transfer resistance (Rct).

FIG. 10 is a graph showing the impact of lowering the concentration of EC in electrolyte solutions on capacity loss.

FIG. 11 is a graph showing the impact of lowering the concentration of EC in electrolyte solutions DCR growth

FIG. 12 is a graph showing the impact of lowering the concentration of EC in electrolyte solutions on gas volume output, respectively.

FIGS. 13A, 13B, and 13C are a series of graphs showing discharge energy loss percentage, DCR growth, and equivalent full cycle data over cycle number for Ni91/graphite pouch cells with various electrolyte solution compositions, measured at 40° C. and 4.25V maximum voltage.

FIGS. 14A and 14B are graphs showing charge transfer resistance (Rct) and formation gas volume measurements for Ni91/graphite pouch cells with different electrolyte solution formulations, demonstrating the impact of LiFSi addition and PRS additive on battery performance parameters.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

Various aspects according to the instant disclosure are directed towards an electrolyte solution used in an energy storage device such as a battery. The electrolyte solution includes a solvent, which includes methyl acetate (MA). Including methyl acetate has the advantage of reducing the charging time of the energy storage device relative to a corresponding energy storage device that does not include methyl acetate. For example, total charge times can be reduced by about 5% to about 35%, about 15% to about 25%, less than, equal to, or greater than about 5%, 6, 7, 8, 9, 10, 11, 12, 13, 14, 15, 16, 17, 18, 19, 20, 21, 22, 23, 24, or about 25%.

While including methyl acetate in the electrolyte solution as a solvent is beneficial, there are several drawbacks associated with using methyl acetate in an energy storage device. For example, including methyl acetate is thought to lead to increased gassing and/or discharge capacity loss or direct current resistance (DCR) growth. However, these drawbacks are mitigated by including additional components such as ethylene carbonate and a lithium salt component such that the energy storage device benefits from the comparatively faster charging without suffering from the aforementioned drawbacks.

An example of a suitable electrolyte solution for an energy storage device includes a solvent and a lithium salt component. The solvent includes methyl acetate. The methyl acetate can be in a range of from about 5 wt % to about 50 wt % of the solvent, about 10 wt % to about 20 wt %, less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 wt % of the solvent. The solvent can further include ethylene carbonate (EC). The ethylene carbonate can range from about 2 wt % to about 19 wt % of the solvent, about 5 wt % to about 15 wt %, less than, equal to, or greater than about 5 wt %, 6, 7, 8, 9, 10, 11, 12, 13, 14, 15, 16, 17, 18, or about 19 wt % of the solvent. It was found that including less than 20 wt % ethylene carbonate in the solvent lead to faster charging in combination with the methyl acetate. Other components that may be present in the solvent can include at least one of ethyl methyl carbonate, diethyl carbonate, propylene carbonate, ethyl acetate, ethyl propionate, or a mixture of at least two thereof.

The lithium salt component can be present in the electrolyte solution at a concentration (molality) of about 0.5 m to about 1.8 m, about 0.8 m to about 1.4 m, less than, equal to, or greater than about 0.5 m, 0.6, 0.7, 0.8, 0.9, 1.0, 1.1, 1.2, 1.3, 1.4, 1.5, 1.6, 1.7, or about 1.8 m. The lithium salt component can include lithium hexafluorophosphate (LiPF₆), lithium bis(fluorosulfonyl)imide (LiFSi), or a combination thereof. In examples where the lithium salt component includes a mixture of LiPF₆ and LiFSi a wt:wt ratio of the salts can range from about 10:1 to about 1:10, about 8:1 to about 1:8, less than, equal to, or greater than about 10:1, 9:1, 8:1, 7:1, 6:1. 5:1, 4:1, 3:1, 2:1, 1:1, 1:2, 1:3, 1:4, 1:5, 1:6, 1:7, 1:8, 1:9, or about 1:10. If only LiFSi is used, the concentration of the lithium salt component can be in a range of from about 0.1 m to about 1.8 m, about 0.6 m to about 1 m, less than, equal to, or greater than about 0.1 m, 0.2, 0.3, 0.4, 0.5, 0.6, 0.7, 0.8, 0.9, 1, 1.1, 1.2, 1.3, 1.4, 1.5, 1.6, 1.7, or about 1.8. If only LiPF₆ is used, the concentration of the lithium salt component can be in a range of from about 0.1 m to about 1.7 m, about 0.6 m to about 1 m, less than, equal to, or greater than about 0.1 m, 0.2, 0.3, 0.4, 0.5, 0.6, 0.7, 0.8, 0.9, 1, 1.1, 1.2, 1.3, 1.4, 1.5, 1.6, or about 1.7.

Further properties of the electrolyte solution and thus the energy storage device can be tuned with various additives. Examples of suitable additives can include 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof. The additive can be present in a range of from about 0.01 wt % to about 3 wt %, about 0.05 wt % to about 2 wt %, less than, equal to, or greater than about 0.01 wt %, 0.05, 1, 1.5, 2, 2.5, or about 5 wt %.

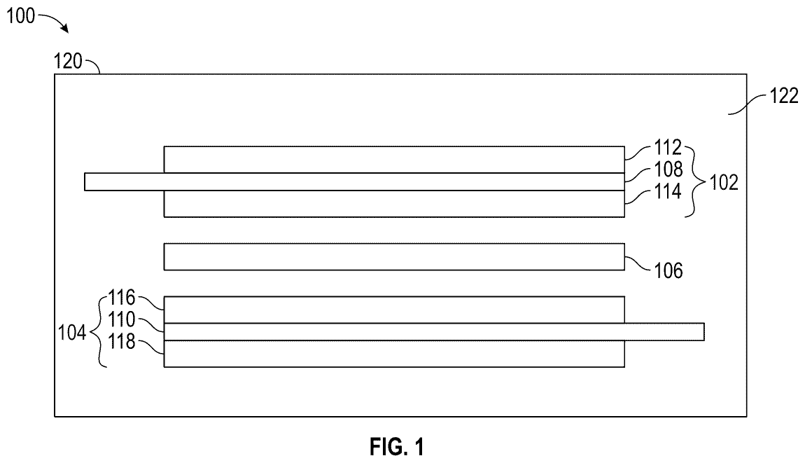

FIG. 1 shows a side cross-sectional schematic view of an example of an energy storage device 100 to which the aforementioned electrolyte solution can be incorporated. The energy storage device 100 may be a lithium-ion capacitor. Of course, it should be realized that other energy storage devices are within the scope of the disclosure, and can include batteries, capacitor-battery hybrids, and/or fuel cells. The energy storage device 100 can have a first electrode 102, a second electrode 104, and a separator 106 positioned between the first electrode 102 and second electrode 104. For example, the first electrode 102 and the second electrode 104 may be placed adjacent to respective opposing surfaces of the separator 106. The first electrode 102 may comprise a cathode and the second electrode 104 may comprise an anode, or vice versa. The energy storage device 100 includes the aforementioned electrolyte solution 122 to facilitate ionic communication between the electrodes 102, 104 of the energy storage device 100. For example, the electrolyte solution 122 may be in contact with the first electrode 102, the second electrode 104 and the separator 106.

The electrolyte solution 122, the first electrode 102, the second electrode 104, and the separator 106 may be received within an energy storage device housing 120. For example, the energy storage device housing 120 may be sealed subsequent to insertion of the first electrode 102, the second electrode 104 and the separator 106, and impregnation of the energy storage device 100 with the electrolyte solution 122, such that the first electrode 102, the second electrode 104, the separator 106, and the electrolyte solution may be physically sealed from an environment external to the housing. electrolyte solution 122 optionally includes one or more additives as provided herein.

The separator 106 can be configured to electrically insulate two electrodes adjacent to opposing sides of the separator 106, such as the first electrode 102 and the second electrode 104, while permitting ionic communication between the two adjacent electrodes. The separator 106 can comprise a variety of porous electrically insulating materials. In some aspects, the separator 106 can comprise a polymeric material. For example, the separator 106 can comprise a cellulosic material (e.g., paper), a polyethylene (PE) material, a polypropylene (PP) material, and/or a polyethylene and polypropylene material.

As shown in FIG. 1, the first electrode 102 and the second electrode 104 include a first current collector 108, and a second current collector 110, respectively. The first current collector 108 and the second current collector 110 may facilitate electrical coupling between the corresponding electrode and an external circuit (not shown). The first current collector 108 and/or the second current collector 110 can comprise one or more electrically conductive materials, and/or have various shapes and/or sizes configured to facilitate transfer of electrical charges between the corresponding electrode and a terminal for coupling the energy storage device 100 with an external terminal, including an external electrical circuit. For example, a current collector can include a metallic material, such as a material comprising aluminum, nickel, copper, silver, alloys thereof, and/or the like. For example, the first current collector 108 and/or the second current collector 110 can comprise an aluminum foil having a rectangular or substantially rectangular shape and can be dimensioned to provide desired transfer of electrical charges between the corresponding electrode and an external electrical circuit (e.g., via a current collector plate and/or another energy storage device component configured to provide electrical communication between the electrodes and the external electrical circuit).

The first electrode 102 may have a first electrode film 112 (e.g., an upper electrode film) on a first surface of the first current collector 108 (e.g., on a top surface of the first current collector 108) and a second electrode film 114 (e.g., a lower electrode film) on a second opposing surface of the first current collector 108 (e.g., on a bottom surface of the first current collector 108). Similarly, the second electrode 104 may have a first electrode film 116 (e.g., an upper electrode film) on a first surface of the second current collector 110 (e.g., on a top surface of the second current collector 110), and a second electrode film 118 on a second opposing surface of the second current collector 110 (e.g., on a bottom surface of the second current collector 110). For example, the first surface of the second current collector 110 may face the second surface of the first current collector 108, such that the separator 106 is adjacent to the second electrode film 114 of the first electrode 102 and the first electrode film 116 of the second electrode 104.

The electrode films 112, 114, 116 and/or 118 can have a variety of suitable shapes, sizes, and/or thicknesses. For example, the electrode films can have a thickness of about 30 microns (μm) to about 250 microns, including about 100 microns to about 250 microns. It will be understood that aspects described herein can be implemented with one or more electrodes, and with electrode(s) that have one or more electrode films, and should not be limited to the aspect shown in FIG. 1.

In some aspects, an electrode film of an anode and/or a cathode of a lithium-ion capacitor comprises a mixture comprising binder material and carbon. In some aspects, the electrode film of an anode and/or a cathode can include one or more additives, including conductive additives. In some aspects, the binder material can include one or more fibrillizable binder components. For example, a process for forming an electrode film can include fibrillizing the fibrillizable binder component such that the electrode film comprises fibrillized binder. The binder component may be fibrillized to provide a plurality of fibrils, the fibrils providing desired mechanical support for one or more other components of the film. For example, a matrix, lattice and/or web of fibrils can be formed to provide desired mechanical structure for the electrode film. For example, a cathode and/or an anode of a lithium-ion capacitor can include one or more electrode films comprising one or more fibrillized binder components. In some aspects, a binder component can include one or more of a variety of suitable fibrillizable polymeric materials, such as polytetrafluoroethylene (PTFE), ultra-high molecular weight polyethylene (UHMWPE), and/or other suitable fibrillizable materials, used alone or in combination.

In some aspects, the electrode film of a lithium-ion capacitor cathode can comprise an electrode film mixture comprising one or more carbon based electroactive components, including for example a porous carbon material, such as activated carbon. In some aspects, the electrode film of a lithium-ion capacitor anode comprises an electrode film mixture comprising carbon configured to reversibly intercalate lithium-ions. In some aspects, the lithium intercalating carbon is graphite. In some aspects, the electrode film of the cathode and/or anode can include an electrical conductivity promoting additive, for example, comprising carbon black.

In some aspects, an energy storage device, such as device 100, can be fabricated by a method comprising providing a cathode and providing an anode, such as electrodes 102, 104; placing a separator, such as separator 106, between the cathode and the anode, inserting the cathode, the anode, and the separator into a housing, such as housing 120, and adding the electrolyte solution 122, to the housing, and contacting the electrolyte with the cathode and the anode.

In some examples, the energy storage device 100 includes a lithium nickel manganese cobalt oxide (NMC) material. lithium nickel manganese cobalt oxide—is a class of mixed metal oxides used as cathode materials in lithium-ion batteries. With the general chemical formula LiNiₓMn_{γ}Co_{1-x-γ}O₂, NMC materials combine the electrochemical strengths of nickel, manganese, and cobalt to deliver high energy density, thermal stability, and long cycle life. These layered compounds allow lithium ions to intercalate and de-intercalate during charge and discharge cycles, making them ideal for applications in electric vehicles, portable electronics, and grid-scale energy storage.

The stoichiometry of NMC—often denoted by ratios such as NMC111, NMC532, or NMC811—determines its performance characteristics. For example, increasing nickel content boosts capacity, while manganese enhances structural stability and cobalt improves conductivity.

The additives described herein can be used in conjunction with energy storage devices including NMC cathodes. However, as shown further herein, it was also found that discharge retention of an energy storage device was affected by the maximum voltage of the energy storage device and the amount of nickel in the NMC material. For example, an NMC material having a nickel content ranging from about 70% to about 91% has good discharge retention. However, if the nickel content is greater than 91% it was found that a maximum operating voltage of about 4.2V yielded the best discharge retention.

In addition to the examples of solvent and additive compositions described above, further examples can include the use of alternative solvent systems, electrode materials, separator configurations, and device architectures to optimize performance for a range of energy storage applications. For example, while methyl acetate and ethylene carbonate are highlighted as primary solvents, other carbonate-based solvents such as propylene carbonate, dimethyl carbonate, or ethyl methyl carbonate may be incorporated in various proportions to adjust the electrolyte's viscosity, dielectric constant, and electrochemical stability. Such co-solvents may be selected to enhance ionic conductivity and compatibility with different electrode chemistries.

The lithium salt component may also include, in certain examples, lithium tetrafluoroborate (LiBF₄), lithium perchlorate (LiClO₄), or lithium difluoro(oxalato)borate (LiDFOB), either alone or in combination with LiPF₆ and LiFSi.

Separator materials may be selected from ceramic-coated polymers, nonwoven fabrics, or composite separators incorporating inorganic fillers, in addition to the polymeric materials previously described. These alternative separators may offer improved mechanical strength, thermal stability, and resistance to dendrite formation, which may be helpful in extending the operational safety and cycle life of the device.

Electrode compositions may be further diversified by incorporating high-capacity anode materials such as silicon, tin, or lithium titanate, either as pure phases or as composites with graphite. Cathode materials may include high-nickel NMC as described herein or lithium iron phosphate (LFP), or lithium cobalt oxide (LCO), with the possibility of surface coatings or dopants to enhance interfacial stability with the disclosed electrolyte solution. The electrode films may also include advanced binders, such as polyvinylidene fluoride (PVDF), carboxymethyl cellulose (CMC), or styrene-butadiene rubber (SBR), in addition to the fibrillizable binders already described.

The energy storage device 100 architecture may be adapted for various form factors, including cylindrical, prismatic, pouch, or coin cell designs. The electrolyte solution may be introduced via vacuum filling, soaking, or direct injection, and the device may be sealed using heat sealing, laser welding, or crimping, depending on the housing material and intended application.

It is further contemplated that the disclosed electrolyte solution may be used in hybrid energy storage devices, such as lithium-ion capacitors, lithium-sulfur batteries, or solid-state batteries, where the unique properties of methyl acetate and ethylene carbonate may facilitate fast ion transport and stable interfacial chemistry. The electrolyte may also be tailored for use in high-voltage systems, with the addition of stabilizing additives or protective coatings on electrode surfaces to mitigate oxidative degradation.

In some examples, the electrolyte solution may be formulated to include flame-retardant additives, such as triphenyl phosphate or organophosphates, to further enhance the safety profile of the energy storage device. The device 100 may also incorporate sensors or monitoring circuits to track electrolyte degradation, gas evolution, or temperature fluctuations, enabling predictive maintenance and improved reliability in demanding applications such as electric vehicles or grid storage.

Additionally, the described electrolyte solution and energy storage device may be integrated into modular battery packs, energy management systems, or smart grids, with provisions for rapid charging, bidirectional energy flow, and adaptive control algorithms to optimize performance under varying load conditions. The system may be configured to communicate with external controllers or diagnostic tools, providing real-time data on state of charge, health, and operational parameters.

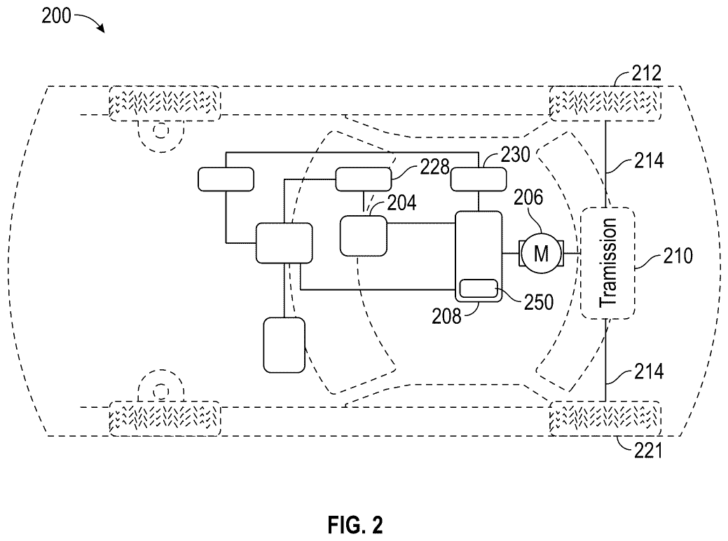

The energy storage device 100 including the aforementioned electrolyte solution can be incorporated in a vehicle. FIG. 2 is a high level diagram of a vehicle 200, according to some aspects. Vehicles include, but are not limited to, ground based vehicles, aquatic vehicles, and aircraft. For the purposes of explanation, the present subject matter focuses on ground based vehicles. In particular.

In various aspects, the vehicle 200 is an electric vehicle and includes a vehicle propulsion energy storage device 204, including the aforementioned electrolyte solution, and at least one propulsion motor 206 for converting battery energy into mechanical motion, such as rotary motion. The present subject matter includes examples in which the energy storage device 204 is a subcomponent of an energy storage system (“ESS”). An ESS includes various components associated with transmitting energy to and from the energy storage device 204 in various examples, including safety components, cooling components, heating components, rectifiers, etc.

A state of charge circuit 228 is pictured to monitor the state of charge of the energy storage device 204. The state of charge circuit can count coulombs, watt-hours, or provide other measure of how much energy is in the energy storage device 204. In some aspects, the state of charge is determined by measuring the battery voltage either open circuited or driving a known load. In additional aspects, the state of charge circuit could optionally provide additional battery information, such as temperature, rate of energy use, number of charge/discharge cycles, and other information relating to battery state. The state of charge circuit 228 can be integrated into an ESS.

Additionally illustrated is an energy converter 208. The energy converter 208 is part of a system which converts energy from the vehicle propulsion energy storage device 204 into energy useable by the at least one propulsion motor 206. In certain instances, the energy flow is from the at least one propulsion motor 206 to the energy storage device 204. As such, in some examples, the energy storage device 204 transmits energy to the energy converter 208, which converts the energy into energy usable by the at least one propulsion motor 206 to propel the electric vehicle. In additional examples, the at least one propulsion motor 206 generates energy that is transmitted to the energy converter 208. In these examples, the energy converter 208 converts the energy into energy which can be stored in the energy storage device 204.

Some examples of the energy converter 208 include one or more field effect transistors. Some examples include metal oxide semiconductor field effect transistors. Some examples include one more insulated gate bipolar transistors. As such, in various examples, the energy converter 208 includes a switch bank which is configured to receive a direct current (“DC”) power signal from the energy storage device 204 and to output a three-phase alternating current (“AC”) signal to power the vehicle propulsion motor 206. In some examples, the energy converter 208 is configured to convert a three phase signal from the vehicle propulsion motor 206 to DC power to be stored in the energy storage device 204. Some examples of the energy converter 208 convert energy from the energy storage device 204 into energy usable by electrical loads other than the vehicle propulsion motor 206. Some of these examples switch energy from approximately 390 Volts DC to 14 Volts DC.

The propulsion motor 206 is, in some aspects, a three phase alternating current (“AC”) propulsion motor, in various examples. Some examples include a plurality of such motors. The present subject matter can optionally include a transmission or gearbox 210 in certain examples. While some examples include a 1-speed transmission, other examples are contemplated. Manually clutched transmissions are contemplated, as are those with hydraulic, electric, or electrohydraulic clutch actuation. Some examples employ a dual-clutch system that, during shifting, phases from one clutch coupled to a first gear to another coupled to a second gear. Rotary motion is transmitted from the transmission 210 to wheels 212 via one or more axles 214, in various examples.

A fuel burning engine 230 is pictured though not a required component (e.g., for a fully electric vehicle). The fuel burning engine can burn any of a variety of fuels, such as fossil fuels, synthetics and biofuels. The fuel burning engine 230 can be controlled to provide a continuous level of power, or can provide a variable level of power via control such as throttle control, as is known. Some aspects operate the fuel burning engine 230 at a level which provides for the highest fuel efficiency.

The fuel burning engine 230 is shown connected to the energy converter 208, such that the fuel burning engine 230 could turn a generator to which it is coupled and provide power to the energy converter 208, but other configurations are possible. For example, in some aspects, an integrated engine generator provides power directly to the energy storage device 204.

The engine can run constantly, but various examples turn the engine on or off based on energy requirements of the vehicle 200. External power 218 is provided to communicate energy with the energy storage device 204, with a reduced overall charging time as discussed above. In various aspects, external power 218 includes a charging station that is coupled to a municipal power grid. In certain examples, the charging station converts power from a 110V AC power source into power storable by the energy storage device 204. In additional examples, the charging station converts power from a 120V AC power source into power storable by the energy storage device 204. Some aspects include converting energy from the energy storage device 204 into power usable by a municipal grid. The present subject matter is not limited to examples in which a converter for converting energy from an external source to energy usable by the vehicle 200 is located outside the vehicle 200, and other examples are contemplated.

### EXAMPLES

Various aspects of the present disclosure can be better understood by reference to the following Examples which are offered by way of illustration. The present disclosure is not limited to the Examples given herein.

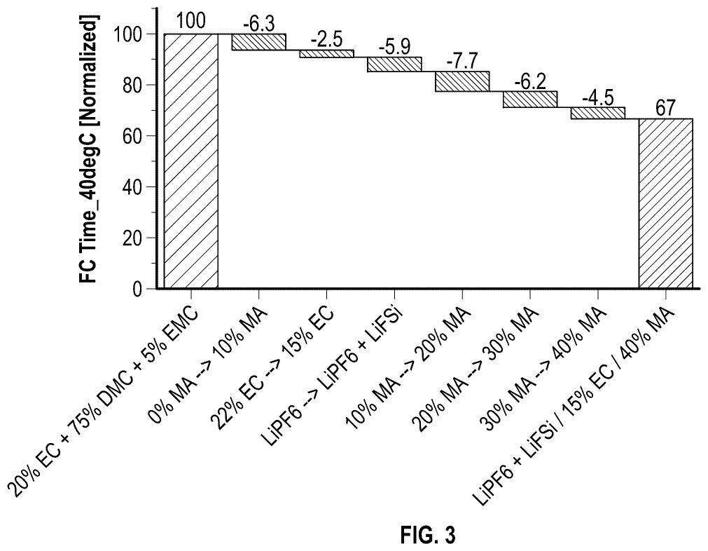

FIG. 3 is a graph showing the Full Charge (FC) time measured at 40° C. of various lithium-ion batteries differing in their electrolyte solution composition. As shown in FIG. 3 the overall full charge time was most reduced using an electrolyte solution that include LiPF₆, LiFSi and a solvent including 15 wt % EC and 20% MA. Moreover it was observed that any negative impact of adding 10% MA can be mitigated by the reduction of EC content (thought to result in less chemical oxidation on cathode surface at high state of charge) and the addition of ˜0.3 m LiFSi (thought to result in better anode passivation and slower cathode DCR growth)

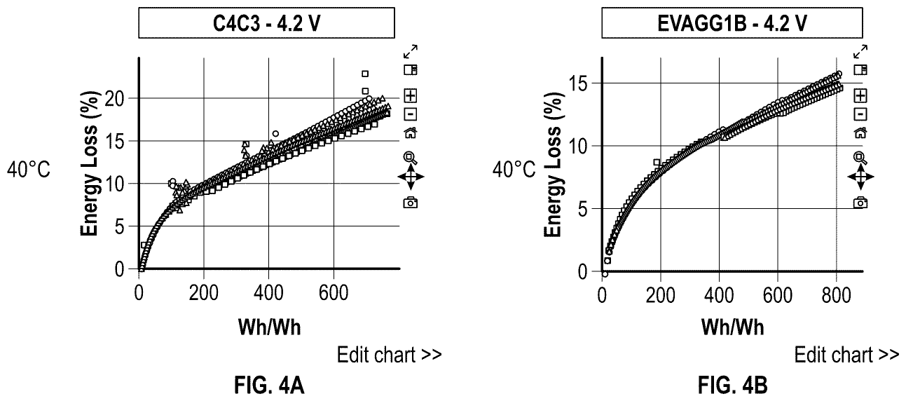

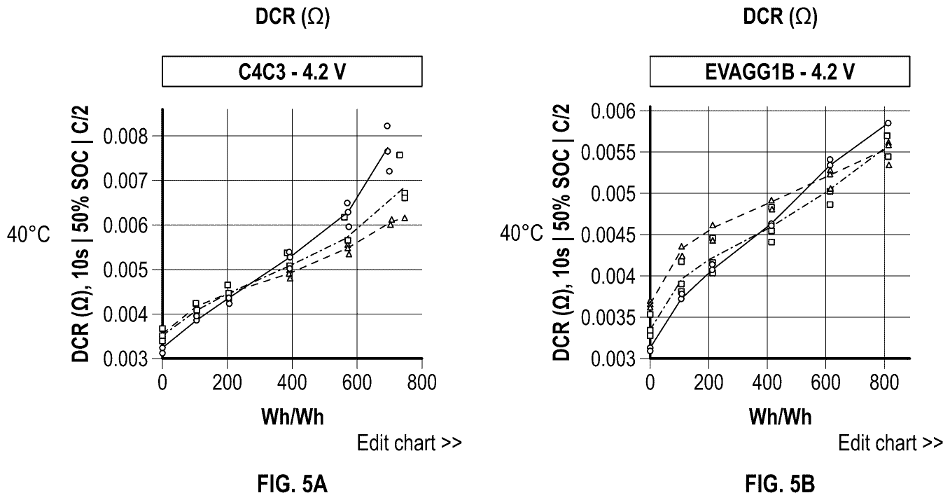

FIGS. 4A and 4B are graphs showing energy loss of various lithium-ion batteries measured at 40° C. differing in their electrolyte solution compositions. FIGS. 5A and 5B show the DCR growths of those same lithium-ion batteries measured at 40° C. As shown, solvents including 10% MA have minimal impact on DCR growth and capacity loss but 20% MA had higher DCR growth, which can be mitigated by lowering EC below the common wt. % percentage of 20-30 wt. % of the solvent.

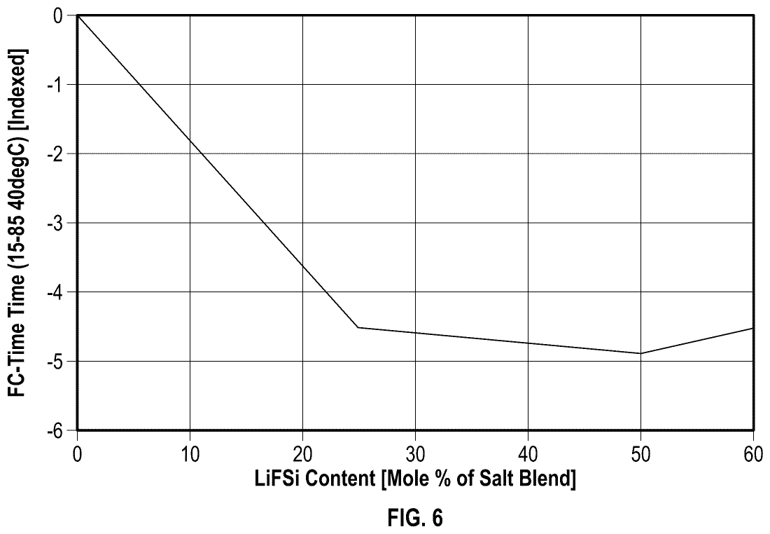

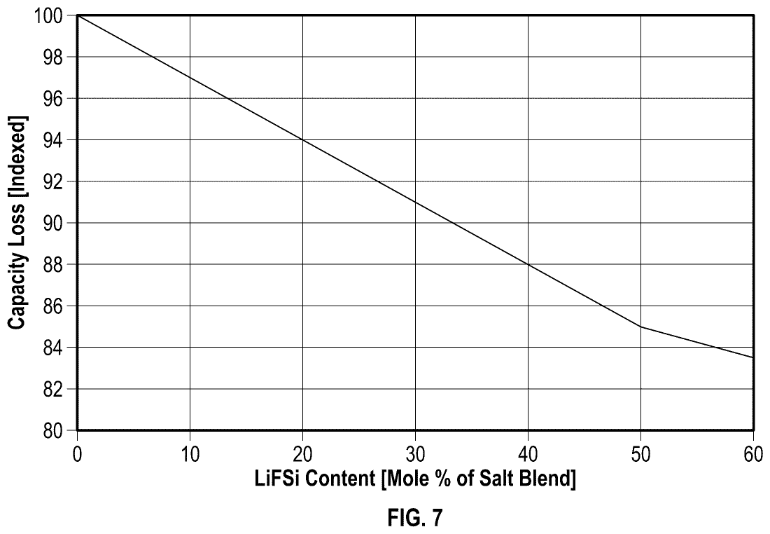

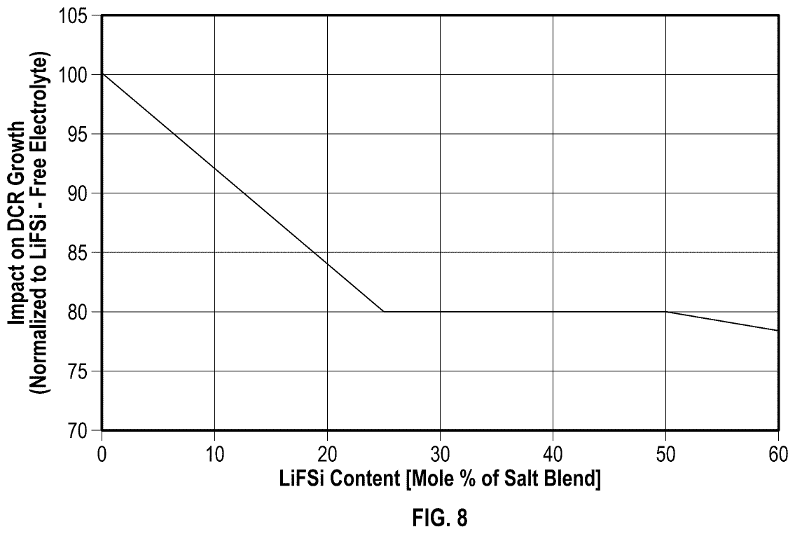

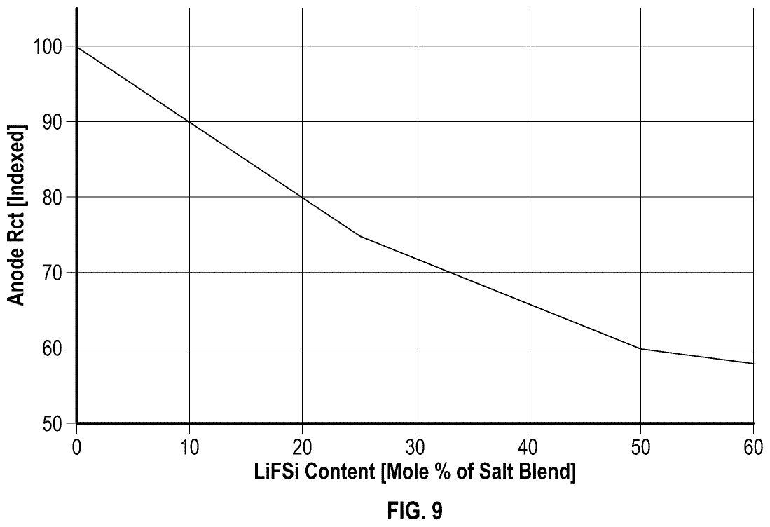

FIGS. 6-9 are a series of graphs showing the impact of the concentration of LiFSi in the electrolyte solution on a lithium-ion battery's full charge time, capacity loss, DCR growth, and anode Rct, respectively. As shown the impact on capacity loss, DCR growth, anode Rct may vary based on baseline cathode/anode/electrolyte formulations. It was also determined that LiFSi can greatly help counter act the impact of MA on DCR growth and baseline shift loss. Additionally, LiFSi can also greatly improve FC time.

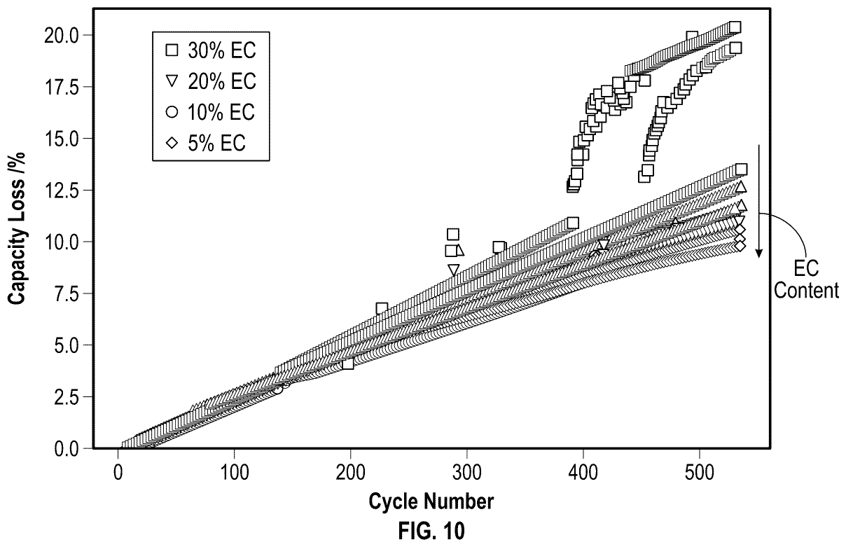

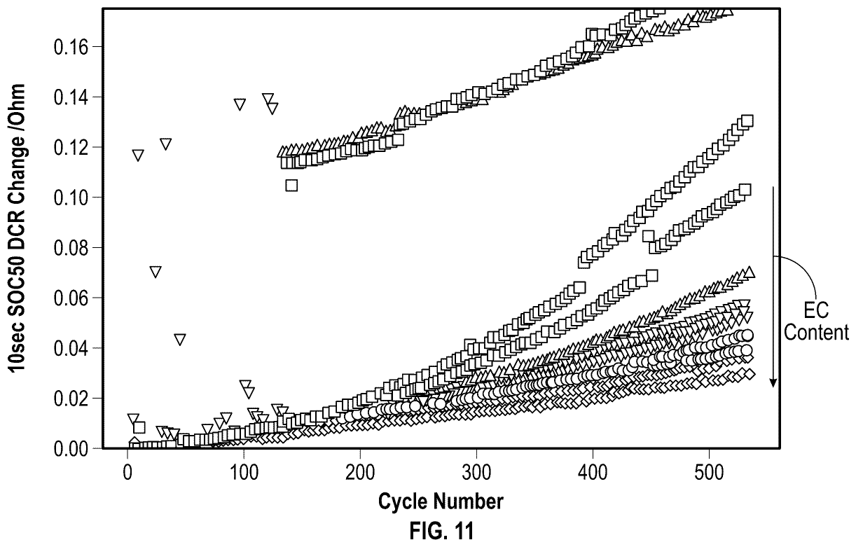

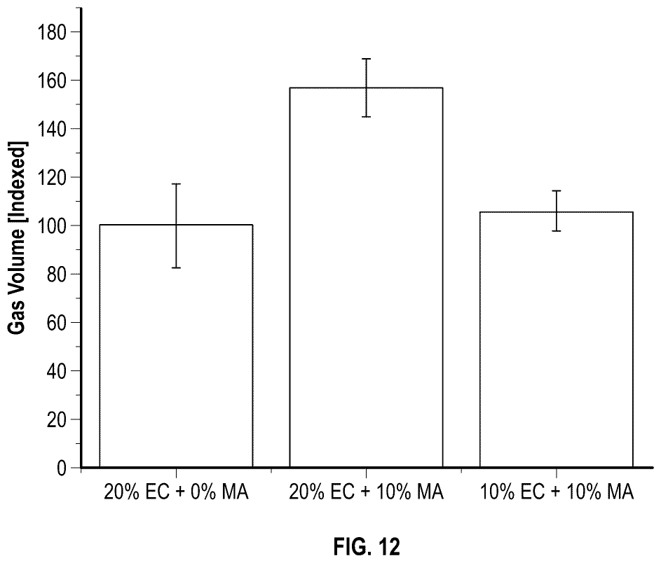

FIGS. 10-12 are a series of graphs showing the impact of lowering the concentration of EC in electrolyte solutions on capacity loss, DCR growth, and gas volume output, respectively. As shown, lowering EC content can help mitigate DCR growth and gassing coming from addition of MA. Additionally, lowering EC reduces the quantity of EC chemically oxidizing on layered cathode surface, it also helps improve fast charge time slightly (˜2.5%).

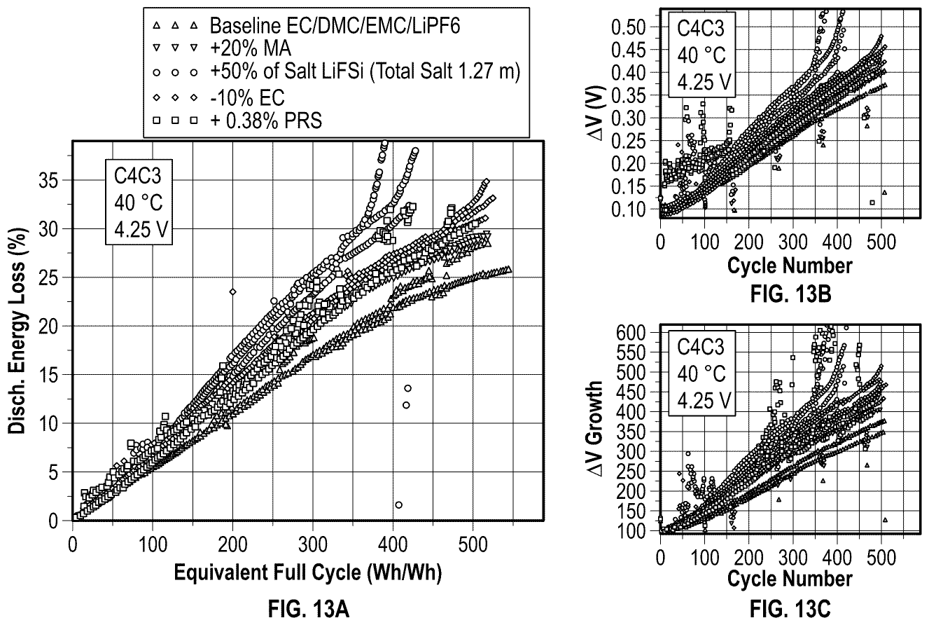

FIGS. 13A, 13B, and 13C show cycling performance data for Ni91/graphite pouch cells tested under C/4 charge and C/3 discharge rates with a maximum voltage of 4.25V at 40° C. The data demonstrates the sequential impact of electrolyte modifications on battery performance. The baseline electrolyte composition without methyl acetate showed relatively stable performance, while the addition of 20 wt % methyl acetate to the baseline electrolyte without LiFSi led to increased energy loss and DCR growth over cycling. However, when half of the LiPF₆ salt was substituted with LiFSi (maintaining a total salt concentration of 1.27 m), the performance initially showed increased loss and resistance growth, which is characteristic behavior observed in high nickel NMC cathodes operated at high voltage. Despite this initial increase, the addition of LiFSi maintained beneficial impacts on fast charge capability. Improvement was achieved through the combined approach of further reducing EC content by 10 wt % and adding 0.38 wt % PRS additive, which resulted in dramatic improvements in both capacity retention and resistance growth characteristics. Results are further shown in Table 1:

TABLE 1

| | LiFSi | LiPF₆ | EC | DMC | EMC | MA | VC | FEC | PRS |
|---|---|---|---|---|---|---|---|---|---|
| Shorthand | [wt %] | [wt %] | [wt %] | [wt %] | [wt %] | [wt %] | [wt %] | [wt %] | [wt %] |
| LiFP₆ DMC base | — | 15.50 | 18.42 | 57.66 | 4.00 | — | 2.87 | 1.54 | — |
| +20% MA | — | 15.46 | 16.03 | 48.08 | — | 16.03 | 2.87 | 1.54 | — |
| +LiFSI | 9.40 | 7.63 | 15.71 | 47.14 | — | 15.71 | 2.87 | 1.54 | — |
| −10% EC | 9.32 | 7.57 | 7.87 | 55.09 | — | 15.74 | 2.87 | 1.54 | — |
| +PRS | 9.28 | 7.54 | 7.84 | 54.87 | — | 15.68 | 2.87 | 1.54 | 0.38 |

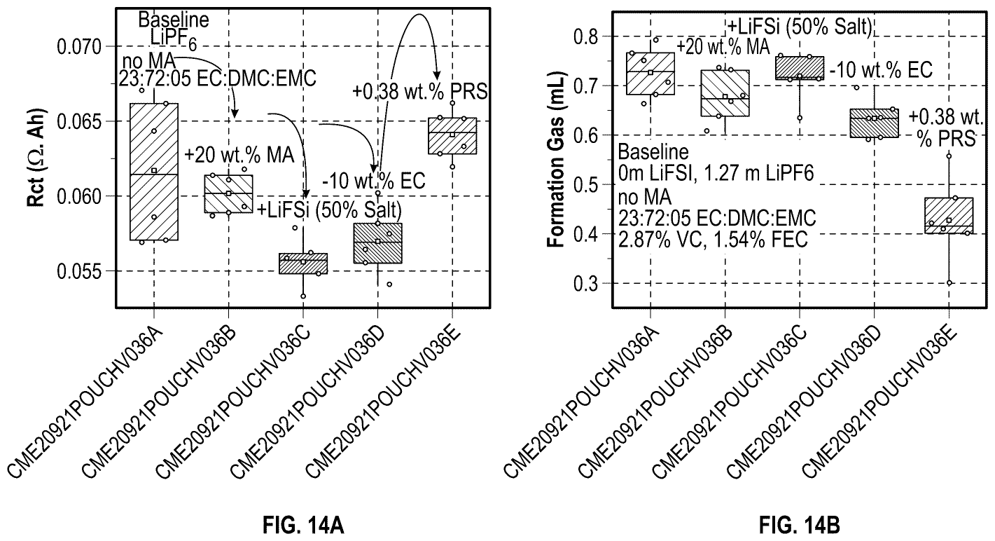

FIGS. 14A and 14B show charge transfer resistance and gas evolution characteristics for the same Ni91/graphite pouch cell system described above with respect to FIG. 13. The charge transfer resistance measurements taken after the formation cycle demonstrate the electrochemical benefits of the LiFSi addition, showing approximately 10% lower charge transfer resistance compared to the baseline formulation. Additionally, the formation gas volume measurements demonstrates a possible advantageous effect of incorporating PRS additive, which reduces gas production during the critical formation process. The data shows a clear progression from the baseline formulation through various modifications, with the final optimized composition containing LiFSi, reduced EC content, and PRS additive achieving the best overall performance in terms of both reduced charge transfer resistance and minimized gas evolution during formation.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Thus, it should be understood that although the present disclosure has been specifically disclosed by specific aspects and optional features, modification and variation of the concepts herein disclosed may be resorted to by those of ordinary skill in the art, and that such modifications and variations are considered to be within the scope of aspects of the present disclosure.

### EXEMPLARY ASPECTS

The following exemplary aspects are provided, the numbering of which is not to be construed as designating levels of importance:
Aspect 1 provides an electrolyte solution comprising:
a solvent comprising:
methyl acetate;
ethylene carbonate; and
a lithium salt component.
Aspect 2 provides the electrolyte solution of Aspect 1, wherein the methyl acetate is in a range of from about 5 wt % to about 50 wt % of the solvent.
Aspect 3 provides the electrolyte solution of any of Aspects 1 or 2, wherein the methyl acetate is in a range of from about 8 wt % to about 15 wt % of the solvent.
Aspect 4 provides the electrolyte solution of any of any of Aspects 1-3, wherein the lithium salt component comprises lithium hexafluorophosphate (LiPF₆), lithium bis(fluorosulfonyl)imide (LiFSi), or a combination thereof.
Aspect 5 provides the electrolyte solution of any of Aspects 1-4, wherein a concentration of the lithium salt component is in a range of from about 0.6 m to about 1.8 m.
Aspect 6 provides the electrolyte solution of any of Aspects 1-5, wherein a concentration of the lithium salt component is in a range of from about 0.8 m to about 1.4 m.
Aspect 7 provides the electrolyte solution of any of Aspects 1-6, wherein the ethylene carbonate is in a range of from about 2 wt % to about 19 wt % of the solvent.
Aspect 8 provides the electrolyte solution of any of Aspects 1-6, wherein the ethylene carbonate is in a range of from about 5 wt % to about 15 wt % of the solvent.
Aspect 9 provides the electrolyte solution of any of Aspects 1-8, wherein the electrolyte solution further comprises an additive component.
Aspect 10 provides the electrolyte solution of Aspect 9, wherein the additive component comprises 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof.
Aspect 11 provides the electrolyte solution of any of Aspects 9 or 10, wherein the additive component ranges from about 0.01 wt % to about 5 wt % of the electrolyte solution.
Aspect 12 provides the electrolyte solution of any of Aspects 1-11, wherein the solvent further comprises at least one of ethyl methyl carbonate, diethyl carbonate, propylene carbonate, ethyl acetate, ethyl propionate, methyl propionate, or a mixture of at least two thereof.
Aspect 13 provides an electrolyte solution comprising:
a solvent comprising:
methyl acetate in a range of from about 5 wt % to about 50 wt % of the solvent; and
ethylene carbonate in a range of from about 2 wt % to about 19 wt % of the solvent; and
a lithium salt component comprising lithium hexafluorophosphate (LiPF₆), lithium bis(fluorosulfonyl)imide (LiFSi), or a combination thereof, wherein a concentration of the lithium salt is in a range of from about 0.6 m to about 1.8 m.
Aspect 14 provides An electrolyte solution comprising:
a solvent comprising:
methyl acetate in a range of from about 5 wt % to about 50 wt % of the solvent; and
ethylene carbonate in a range of from about 2 wt % to about 19 wt % of the solvent;
a lithium salt component comprising lithium hexafluorophosphate (LiPF₆), lithium bis(fluorosulfonyl)imide (LiFSi), or a combination thereof, wherein a concentration of the lithium salt is in a range of from about 0.1 m to about 0.5 m; and
an additive component comprising dichlorodiphenyltrichloroethane (DTD), 1-Propene 1,3-Sultone (PRS), bis-dichlorodiphenyltrichloroethane (bis-DTD), or a mixture of at least two thereof.
Aspect 15 provides an energy storage device comprising:
a cathode;
an anode
a separator between the cathode and the anode; and
an electrolyte solution comprising:
a solvent comprising:
   methyl acetate;
   ethylene carbonate; and
a lithium salt component.
Aspect 16 provides the energy storage device of Aspect 15, wherein the methyl acetate is in a range of from about 5 wt % to about 50 wt % of the solvent.
Aspect 17 provides the energy storage device of any of Aspects 15 or 16, wherein the methyl acetate is in a range of from about 10 wt % to about 20 wt % of the solvent.
Aspect 18 provides the energy storage device of any of any of Aspects 15-17, wherein the lithium salt component comprises lithium hexafluorophosphate (LiPF₆), lithium bis(fluorosulfonyl)imide (LiFSi), or a combination thereof.
Aspect 19 provides the energy storage device of any of any of Aspects 15-18, wherein a concentration of the lithium salt component is in a range of from about 0.6 m to about 1.8 m.
Aspect 20 provides the energy storage device of any of any of Aspects 15-19, wherein a concentration of the lithium salt component is in a range of from about 0.8 m to about 1.4 m.
Aspect 21 provides the energy storage device of any of any of Aspects 15-20, wherein the ethylene carbonate is in a range of from about 2 wt % to about 19 wt % of the solvent.
Aspect 22 provides the energy storage device of any of any of Aspects 15-21, wherein the ethylene carbonate is in a range of from about 5 wt % to about 15 wt % of the solvent.
Aspect 23 provides the energy storage device of any of any of Aspects 15-22, wherein the electrolyte solution further comprises an additive component.
Aspect 24 provides the energy storage device of Aspect 23, wherein the additive component comprises 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof.
Aspect 25 provides the energy storage device of any of any of Aspects 23 or 24, wherein the additive component ranges from about 0.01 wt % to about 5 wt % of the electrolyte solution.
Aspect 26 provides the energy storage device of any of any of Aspects 23-25, wherein the solvent further comprises at least one of ethyl methyl carbonate, diethyl carbonate, propylene carbonate, ethyl acetate, ethyl propionate, or a mixture of at least two thereof.
Aspect 27 provides a method of fabricating an energy storage device, the method comprising:
placing a separator between a cathode and an anode;
inserting the cathode, the anode, and the separator into a housing;
adding an electrolyte solution to the housing;
and contacting the electrolyte solution with the cathode and the anode, wherein the electrolyte solution comprises:
a solvent comprising:
   methyl acetate;
   ethylene carbonate; and
a lithium salt component.
Aspect 28 provides the method of Aspect 27, wherein the methyl acetate is in a range of from about 5 wt % to about 50 wt % of the solvent.
Aspect 29 provides the method of any of Aspects 27 or 28, wherein the methyl acetate is in a range of from about 10 wt % to about 20 wt % of the solvent.
Aspect 30 provides the method of any of any of Aspects 27-29, wherein the lithium salt component comprises lithium hexafluorophosphate (LiPF₆), lithium bis(fluorosulfonyl)imide (LiFSi), or a combination thereof.
Aspect 31 provides the method of any of any of Aspects 27-30, wherein a concentration of the lithium salt component is in a range of from about 0.6 m to about 1.8 m.
Aspect 32 provides the method of any of any of Aspects 27-31, wherein a concentration of the lithium salt component is in a range of from about 0.8 m to about 1.4 m.
Aspect 33 provides the method of any of any of Aspects 27-32, wherein the ethylene carbonate is in a range of from about 2 wt % to about 19 wt % of the solvent.
Aspect 34 provides the method of any of any of Aspects 27-33, wherein the ethylene carbonate is in a range of from about 5 wt % to about 15 wt % of the solvent.
Aspect 35 provides the method of any of any of Aspects 27-34, wherein the electrolyte solution further comprises an additive component.
Aspect 36 provides the method of Aspect 35, wherein the additive component comprises 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof.
Aspect 37 provides the method of any of any of Aspects 35 or 36, wherein the additive component ranges from about 0.01 wt % to about 5 wt % of the electrolyte solution.
Aspect 38 provides the method of any of any of Aspects 35-37, wherein the solvent further comprises at least one of ethyl methyl carbonate, diethyl carbonate, propylene carbonate, ethyl acetate, ethyl propionate, or a mixture of at least two thereof.
Aspect 39 provides a vehicle, comprising:
a motor, the motor providing propulsion power to the vehicle; and an energy storage device coupled to the motor and providing energy to the motor, wherein the energy storage device comprising:
a cathode;
an anode
a separator between the cathode and the anode; and
an electrolyte solution comprising:
   a solvent comprising:
      methyl acetate;
      ethylene carbonate; and
   a lithium salt component.
Aspect 40 provides the vehicle of Aspect 39, wherein the methyl acetate is in a range of from about 5 wt % to about 50 wt % of the solvent.
Aspect 41 provides the vehicle of any of Aspects 39 or 40, wherein the methyl acetate is in a range of from about 10 wt % to about 20 wt % of the solvent.
Aspect 42 provides the vehicle of any of any of Aspects 39-41, wherein the lithium salt component comprises lithium hexafluorophosphate (LiPF₆), lithium bis(fluorosulfonyl)imide (LiFSi), or a combination thereof.
Aspect 43 provides the vehicle of any of any of Aspects 39-42, wherein a concentration of the lithium salt component is in a range of from about 0.6 m to about 1.8 m.
Aspect 44 provides the vehicle of any of any of Aspects 39-43, wherein a concentration of the lithium salt component is in a range of from about 0.8 m to about 1.4 m.
Aspect 45 provides the vehicle of any of any of Aspects 39-44, wherein the ethylene carbonate is in a range of from about 2 wt % to about 19 wt % of the solvent.
Aspect 46 provides the vehicle of any of any of Aspects 39-45, wherein the ethylene carbonate is in a range of from about 5 wt % to about 15 wt % of the solvent.
Aspect 47 provides the vehicle of any of any of Aspects 39-46, wherein the electrolyte solution further comprises an additive component.
Aspect 48 provides the vehicle of Aspect 47, wherein the additive component comprises 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof.
Aspect 49 provides the vehicle of any of any of Aspects 47 or 48, wherein the additive component ranges from about 0.01 wt % to about 5 wt % of the electrolyte solution.
Aspect 50 provides the vehicle of any of any of Aspects 47-49, wherein the solvent further comprises at least one of ethyl methyl carbonate, diethyl carbonate, propylene carbonate, ethyl acetate, ethyl propionate, or a mixture of at least two thereof.

What is claimed is:

1. An electrolyte solution comprising:
a solvent comprising:
methyl acetate;
ethylene carbonate; and
a lithium salt component.

2. The electrolyte solution of claim 1, wherein the methyl acetate is in a range of from about 5 wt % to about 50 wt % of the solvent.

3. The electrolyte solution of claim 1, wherein the lithium salt component comprises lithium hexafluorophosphate (LiPF₆), lithium bis(fluorosulfonyl)imide (LiFSi), or a combination thereof.

4. The electrolyte solution of claim 1 wherein a concentration of the lithium salt component is in a range of from about 0.5 m to about 1.8 m.

5. The electrolyte solution of claim 1, wherein the ethylene carbonate is in a range of from about 2 wt % to about 19 wt % of the solvent.

6. The electrolyte solution of claim 1, wherein the electrolyte solution further comprises an additive component.

7. The electrolyte solution of claim 6, wherein the additive component comprises 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof.

8. The electrolyte solution of claim 6, wherein the additive component ranges from about 0.01 wt % to about 5 wt % of the electrolyte solution.

9. The electrolyte solution of claim 1, wherein the solvent further comprises at least one of ethyl methyl carbonate, diethyl carbonate, propylene carbonate, ethyl acetate, ethyl propionate, or a mixture of at least two thereof.

10. An electrolyte solution comprising:
a solvent comprising:
methyl acetate in a range of from about 5 wt % to about 50 wt % of the solvent; and
ethylene carbonate in a range of from about 2 wt % to about 19 wt % of the solvent;
a lithium salt component comprising lithium hexafluorophosphate (LiPF₆), lithium bis(fluorosulfonyl)imide (LiFSi), or a combination thereof, wherein a concentration of the lithium salt component is in a range of from about 0.6 m to about 1.8 m; and
an additive component comprising 1,3,2-Dioxathiolane 2,2-dioxidee (DTD), 1-Propene 1,3-Sultone (PRS), bis-1,3,2-Dioxathiolane 2,2-dioxide (bis-DTD), vinyl carbonate, fluoroethylene carbonate, Lithium tetrafluoro oxalate phopshate (LiTFOP), lithium difluoro phosphate (LFO), Bis(trimethylsilyl) malonate, Lithium tetrafluoro malono phosphate, 1,2,6-Oxadithiane, 2,2,6,6-tetraoxide, 4-Vinyl-1,3-dioxolan-2-one, or a mixture of at least two thereof.

11. An energy storage device comprising:
a cathode;
an anode
a separator between the cathode and the anode; and
an electrolyte solution comprising:
a solvent comprising:
methyl acetate;
ethylene carbonate; and
a lithium salt component.

12. The energy storage device of claim 11, wherein the methyl acetate is in a range of from about 5 wt % to about 50 wt % of the solvent.

13. The energy storage device of claim 11, wherein the lithium salt component comprises lithium hexafluorophosphate (LiPF₆), lithium bis(fluorosulfonyl)imide (LiFSi), or a combination thereof.

14. The energy storage device of claim 11, wherein a concentration of the lithium salt component is in a range of from about 0.6 m to about 1.8 m.

15. The energy storage device of claim 11, wherein a concentration of the lithium salt component is in a range of from about 0.8 m to about 1.4 m.

16. The energy storage device of claim 11, wherein the ethylene carbonate is in a range of from about 2 wt % to about 19 wt % of the solvent.

17. The energy storage device of claim 11, wherein the electrolyte solution further comprises an additive component.

18. The energy storage device of claim 17, wherein the additive component comprises dichlorodiphenyltrichloroethane (DTD), 1-Propene 1,3-Sultone (PRS), bis-dichlorodiphenyltrichloroethane (bis-DTD), or a mixture of at least two thereof.

19. The energy storage device of claim 17, wherein the additive component ranges from about 0.01 wt % to about 5 wt % of the electrolyte solution.

20. The energy storage device of claim 11, wherein the solvent further comprises at least one of ethyl methyl carbonate, diethyl carbonate, propylene carbonate, ethyl acetate, ethyl propionate, or a mixture of at least two thereof.
